(19) United States
(12) Patent Application Publication
(10) Pub. No.: US 2005/0054234 A1
(43) Pub. Date: Mar. 10, 2005

(54) Electric connector for the motor of a hermetic compressor and its manufacturing process

(76) Inventors: Joao Carlos Dobner Daniel, Joinville Sc (BR); Landoaldo Victor Lindroth Junior, Joinville Sc (BR); Emerson Moreira, Joinville Sc (BR); Orlando Starke, Joinville Sc (BR)

Correspondence Address: DARBY & DARBY P.C., P. O. BOX 5257, NEW YORK, NY, 10150-5257, US

(21) Appl. No.: 10/485,672

(22) PCT Filed: Jul. 29, 2002
(86) PCT No.: PCT/BR02/00106

(30) Foreign Application Priority Data
Jul. 30, 2001 (BR) PI 0104134-7

(51) Int. Cl. H01R 13/627

(52) U.S. Cl. 439/357

(57) ABSTRACT

An electric connector for the motor of a hermetic compressor and its manufacturing process, said motor carrying in the stator (6) thereof a female connector (10) for electric connection and being mounted inside a shell (1) to which is affixed a power inlet plug (8) for connection to an external current supply source, said connector comprising an electric insulating body to be engaged to the female connector (10) and carrying: a plurality of binding posts (31) connecting and affixing a first end portion (21) of each respective conductor (20), which has a second end portion (22) to be connected to a power inlet plug (8) of the shell (1); and fixation means to be fitted into engagement receiving means provided in the female connector (10), in order to immobilize said parts against relative movements, said male connector (30) being obtained by over-injecting insulating material to each first end portion (21) of each conductor (20) connected to the insulating body of the male connector (30), in order to immobilize said conductors (20).

### FIELD OF THE INVENTION

The present invention refers to a male connector to establish an electric connection in a motor provided inside the shell of a hermetic compressor of the type used in refrigeration appliances, such as refrigerators, freezers, water fountains, etc. and, more particularly, to establish a connection between the power supply cable and the electric motor of the compressor. The invention further refers to a process for manufacturing said connector.

### BACKGROUND OF THE INVENTION

The motor of a hermetic compressor usually comprises, mounted inside its hermetic shell, a rotor and a stator, the latter being formed by a main coil and a secondary coil, said motor being fed by an electric current from a power source external to said hermetic shell, by connecting an appropriate wiring to a power inlet plug mounted external to the hermetic shell and which is electrically connected to the stator of the electric motor.

In a known construction, in order to connect the stator to the power inlet plug of the hermetic shell, through the interior of the latter, some copper wires of the stator, generally three, are connected to a cable by clamping a metallic piece, which is exposed inside the compressor and joins each copper wire to the cable that is then connected to the shell. After clamping the two parts together, for each wire, the formed assembly receives a thermal retractile insulating cover that protects said connection thus obtained. After the connection, the whole assembly is positioned inside the coils that form the motor.

This construction presents some disadvantages, such as difficult automation, for example in the clamping steps, which also results in low quality of the obtained electric connections, with a high number of defects and rejections, for example due to low efficiency of the desired connection and to failures in the manufacturing process of said connection.

In this construction, there is a connection provided directly to the connector attached to the stator of the electric motor. In such solution, after fitting the cable to the connector attached to the stator, the assembly receives a metallic clamp that bites the cables to the connector.

In order to effectively accomplish this type of connection, it is necessary to prevent the relative movement of the connected parts defined by the male connector and the female connector that is affixed to the stator. The relative movement existing between the attached parts allows fatigue of contacts to occur, which can increase the voltage drop in the connection region, or even cause rupture of said connection. Furthermore, the occurrence of movement may cause temperature increase at the connection region and a consequent short-circuit, resulting in general failure of the connection.

Some known constructions that use a male connector and a female connector to make the contact between the electric motor and the power inlet plug of the hermetic shell have visible sharp metallic ends located inside the compressor and which can be energized. Such energized ends may attract metallic filings eventually existing inside the shell of the compressor and which may provoke short-circuit within the latter.

In other known construction, the electric connections from the motor to the shell of the compressor occur through a male connector that presents a cover portion closing a bottom portion. In this construction, the fitting of the male connector to the female connector occurs with great relative movement between said parts, which is inherent to the construction of the connection itself. In this construction, the electric cable presents a connection that allows great relative movement between the connected parts. This construction presents a metallic male connecting terminal that only provides an electric contact to the female connector, with no fixation being made between the parts defined by the male connecting terminal and the female connector.

In this construction, the male connecting terminal defines only a structure that carries the electric terminals of the supply cable, which does not impart rigidity to the male connector.

The male connector of this construction presents two component parts, one of them being a bottom portion, on which are placed the electric terminals of the supply cable and which receives a closing portion to be locked on the bottom portion. Such construction presents fitting gaps between said fitted parts that allow the occurrence of relative movements and vibrations. In this construction, the male contacts are not rigidly attached inside the compressor in the stator, and this non-rigid fixation is what allows the relative movement to occur. On the other hand, the connection between the binding posts of both the male and female connectors do not present a steady fixation either, with said binding posts being only mutually fitted, which does not assure stability to the connection.

The existence of movement permits the occurrence of voltage drop that generates temperature increase (to about 100° C.).

Other disadvantage of the above-mentioned connection refers to the process in the assembly line. In order to carry out this assembly, the connectors should be perfectly aligned, so that their terminals are also perfectly aligned and contacting each other. Otherwise, the connection will not allow the desired contact to take place and, besides this fact, the connection may be damaged. In case of poor contact, problems such as vibrations and relative movements will also occur, as discussed above.

### OBJECTS OF THE INVENTION

Thus, it is an object of the present invention to provide a male connector for the electric connection in the motor of a hermetic compressor, which allows a safe and strong fixation of the internal portion of the supply cable inside the hermetic shell to the electric motor of the compressor, without the disadvantages of rupture, fatigue and voltage drop.

It is another object of the present invention to provide an electric connector with the characteristics mentioned above, which allows manufacturing the desired electric connection in a substantially automated form.

A further object of the present invention is to provide a connector such as mentioned above, for fitting the female connector described in the Brazilian co-pending application PI 0006484-0 of the same applicant.

Another object of the present invention is to provide a process for manufacturing the present male connector.

### SUMMARY OF THE INVENTION

These and other objects are attained by a male connector for the motor of a hermetic compressor, said motor carrying in the stator thereof a female connector for electric connection, and being mounted inside a shell to which is affixed a power inlet plug for connection to an external current supply source, said male connector comprising an electric insulating body to be engaged to the female connector and carrying: a plurality of binding posts connecting and affixing a first end portion of each respective conductor, which has a second end portion to be connected to the power inlet plug of the shell; and fixation means to be fitted into engagement receiving means provided in the female connector, in order to immobilize said parts against relative movements.

The male connector of the present invention is manufactured by a process comprising the steps of: a—providing an electric insulating body carrying a plurality of binding posts connecting and affixing a first end portion of each respective conductor, which has a second end portion to be connected to a power inlet plug of the shell; b—mounting electric contact terminals of each conductor to the binding posts mounted in the electric insulating body of the male connector; and c—over-injecting insulating material to each first end portion of each conductor connected to the insulating body of the male connector, in order to immobilize said conductors, with the step “b” being carried out in a mold that receives an injection of plastic.

### BRIEF DESCRIPTION OF THE DRAWINGS

The invention will be described below, with reference to the enclosed drawings, in which:

FIG. 1 is a longitudinal diametrical sectional view of a hermetic compressor of the reciprocating type and with a vertical shaft, presenting an electric connection between the motor and the compressor shell, using the electric connector of the present invention;

FIG. 2 is a bottom view of the stator of the electric motor to which is mounted the male connector of the present invention;

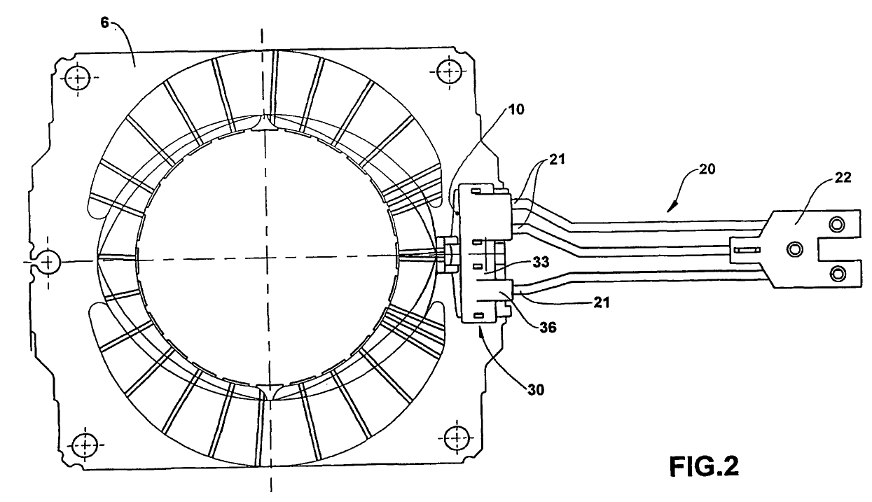

FIG. 3 is a lateral view of the male connector of the present invention, mounted to the stator of an electric motor;

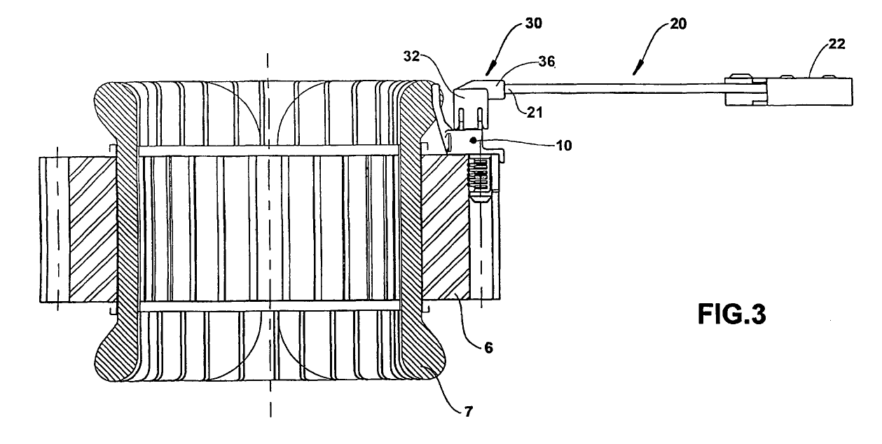

FIG. 4 is a lower perspective view of the male connector illustrated in FIG. 1; and

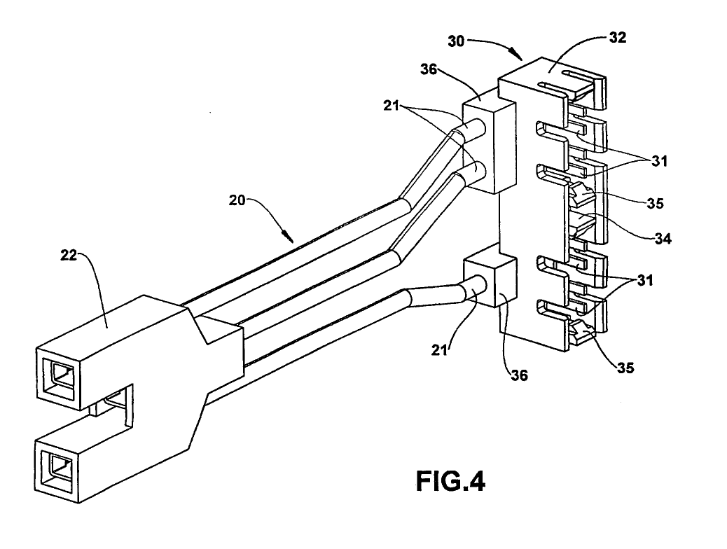

FIG. 5 is an upper perspective view of the male connector of the present invention, to be fitted into a female connector of the type described in the Brazilian co-pending Application PI 0006484-0.

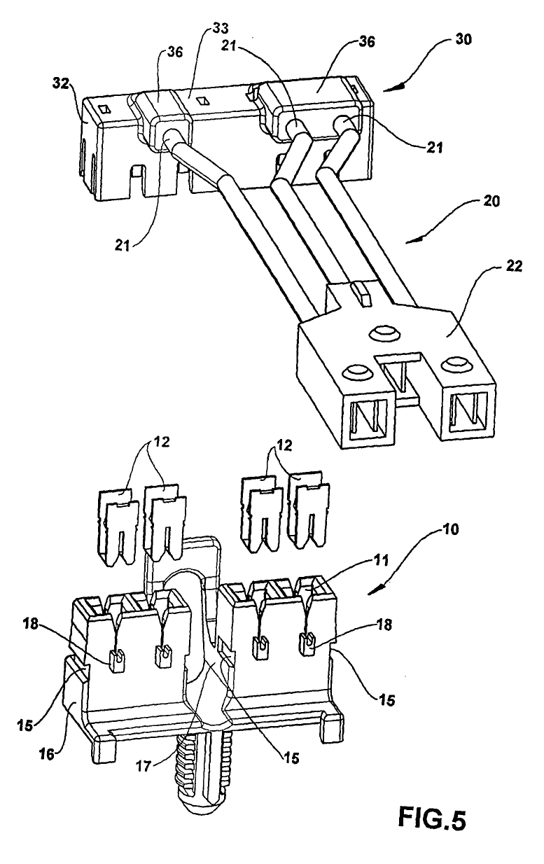

### DESCRIPTION OF THE ILLUSTRATED EMBODIMENT

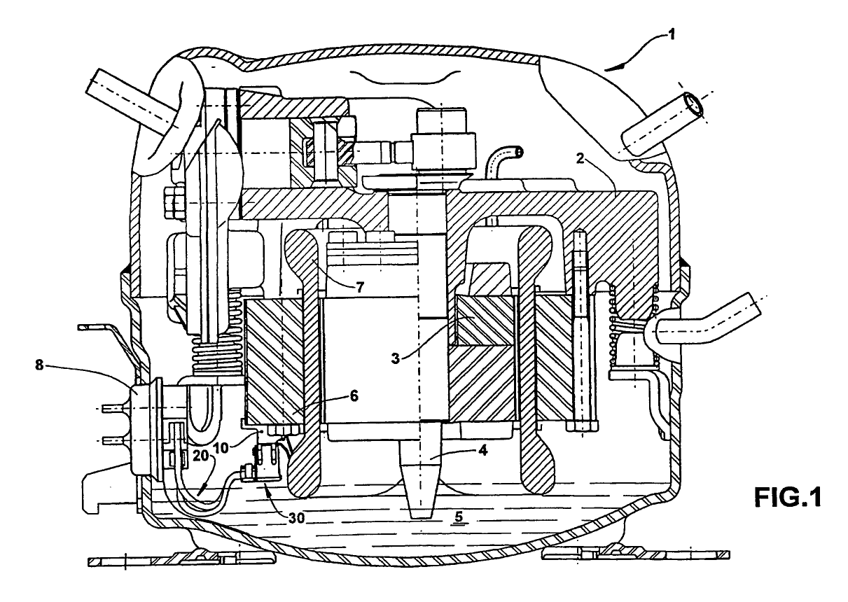

The present invention will be described below in relation to a reciprocating compressor used in refrigeration systems, of the vertical shaft type (FIG. 1) and comprising a hermetic shell 1, inside which is adequately suspended, for example by springs, a motor-compressor assembly formed by a cylinder block 2, to which is attached an electric motor, whose rotor 3 is mounted to a vertical crankshaft 4 supported by a main bearing machined in the cylinder block 2. The crankshaft 4 sustains, inferiorly, a pump rotor that carries oil from an oil sump 5 to parts of the cylinder block 2 in need of lubrication during the operation of the compressor.

The electric motor of the compressor comprises, besides the rotor 3, a stator 6 formed by a stack of metallic laminations, which are overlapped to define axial housings to receive coil windings 7 from the electric motor.

The electric motor is fed from an adequate external supply source (not illustrated), by means of an electric connection provided between this current supply source and a power inlet plug 8 carried by the shell 1 and that is electrically connected to the electric motor of the compressor.

Against the stack of laminations of the stator 6, for example against one of the end laminations thereof, there is attached a female connector 10 of the type described in Brazilian co-pending Application PI 0006484-0 and which, by means of conductors 20, electrically connects the electric motor of the compressor to the power inlet plug 8.

According to the present invention, the electric connection between the female connector 10 and the power inlet plug 8 is made by a male connector 30 affixing the conductors 20 and which is fitted to the female connector 10 disposed in the stack of laminations that defines the stator 6, as described in co-pending Application PI 0006484-0.

In the illustrated embodiment, the female connector 10 comprises an electric insulating body to be attached to the stator 6 and which defines a plurality of housings 11, each carrying a respective binding post 12 and receiving a corresponding binding post 31 from the male connector 30, so as to electrically connect the windings of the electric motor to the power inlet plug 8 of the shell 1.

The male connector 30 of the present invention comprises an electric insulating body, in a single piece and of prismatic shape, presenting lateral walls 32 projecting from a rear wall 33, said insulating body defining, in the interior thereof, a plurality of housings, each carrying a binding post 31 for connecting and attaching one end of a respective conductor 20, the conductors 20 being arranged for example in the form of a conventional harness, each conductor 20 having a first end portion 21 attached to the male connector 30 of the present invention, and a second end portion 22 to be connected to the power inlet plug 8 of the compressor. The electric insulating body of the male connector 30 of the present invention is defined so that no electric contacts can be accessed external to said insulating body, independently of the mounting condition of this connector.

The electric insulating body of the male connector 30 further presents at least one internal wall 34, for example two, separating the housings for the binding posts 31 of said male connector 30.

According to the present invention, in order that the fitting of the present male connector 30 to the female connector 10 attached in the stator 6 does not present mobility after the mutual assembly, the male connector 30 is provided with fixation means, for example in the form of teeth 35 to be fitted into corresponding engaging means provided in the female connector 10, for avoiding the involuntary relative movements between said male connector 30 and the female connector 10, at least relative to the mutual separation thereof in the fitting direction of said connectors.

The fixation between the male connector 30 and the female connector 10 obtained with the solution of the present invention prevents the occurrence of relative movement between said parts, thus avoiding the occurrence of fatigue in the contacts thereof and, consequently, an increase in the voltage drops due to contact failure and temperature increase in the connection region, which can cause general failure in the connection or even a short-circuit.

According to the illustrations, the engaging means of the female connector 10 are in the form of windows produced in external lateral walls 16 and internal lateral walls 17 of the basic body of said female connector 10. In the illustrated embodiment, the external lateral walls 16 present an indented portion, for instance in the form of an increase in the thickness of said wall in this region, which forces the elastic deformation of a respective tooth 35 of the male connector 30 during the assembly of the latter to the female connector 10, and which defines a stop to avoid said tooth 35 from coming out from the corresponding cutout 15, after said tooth 35 has been seated on the latter.

The female connector 10 further presents a plurality of projections 18 provided from at least one of the front and rear walls of the basic body of said female connector 10 and which define guides for fitting the male connector 30.

In the illustrated constructive solution, only the laterals walls 32, in the respective internal face confronting with a respective internal wall 34 of the insulating body of the present male connector 30, are provided with teeth 35. In this construction, each lateral wall 32 provided with a tooth 35 is resiliently flexible, in order to be deformed upon engagement of the male connector 30 to the female connector 10.

According to the illustrations, the insulating body of the male connector 30 of the present invention defines, close to the housings that receive the binding posts 31, the electric contact terminals, which connect the electric terminals thereof to the power inlet plug 8 of the shell 1 of the compressor.

According to the present invention, the electric insulating body of the present male connector 30 further comprises retaining means, which affix each first end portion 21 of the conductors 20 to the electric insulating body of the male connector 30, so as to avoid the occurrence of relative movements between these parts. This incorporation occurs in the manufacturing process of the male connector 30 after the formation of the electric insulating body thereof, by the steps of: mounting electric contact terminals of each first end portion of the conductors 20 to the binding posts of said electric insulating body of the male connector 30; and over-injecting an insulating material to and around said first end portion 21 of the conductors 20, in order to immobilize said conductors 20 in relation to the insulating body of the male connector 30 in the region adjacent to the latter, avoiding relative movement to occur between said parts. These steps are performed, for example, by mounting said terminals to the electric insulating body of the present male connector 30 in a mold that is injected with insulating material, for instance plastic, so that said assembly defines a single body, with no gaps and with no relative movements.

In the illustrated construction, the insulating body of the male connector 30 presents projections 36 extending from a portion of one of the lateral walls 32 of said insulating body, for example one of those not provided with the teeth 35 and which surrounds an adjacent portion of the rear wall 33 of said insulating body and the first end portion 21 of each conductor 20, said projections 36 defining the retaining means of the male connector 30 in relation to the conductors 20.

According to the illustrations, and such as occurs with the female connector 10, the contact housings of the electric insulating body of the male connector 30 are of the type presenting an upper inlet, whose bottom portion (not illustrated) is opened to a cradle that receives a wire portion of the conductors 20, in order to retain the respective conductor and avoid its movement, as well as a possible rupture due to fatigue resulting, for example, from vibration of the compressor during operation thereof.

With the solution of the present invention, the connection of the wires of the electric motor with the power inlet plug 8 of the compressor shell occurs external and no more internal to the female connector 10, as in the prior art, without being possible to occur movements and stresses on the wires of the conductors, thus avoiding the disadvantages of the known constructions discussed above.

Furthermore, such solution allows the compressor to be automatically mounted, which has not been reached before.

1. An electric connector for the motor of a hermetic compressor, said motor carrying in the stator (6) thereof a female connector (10) for electric connection and being mounted inside a shell (1) to which is affixed a power inlet plug (8) for connection to an external current supply source, characterized in that it comprises an electric insulating body to be engaged to the female connector (10) and carrying:
a plurality of binding posts (31) connecting and affixing a first end portion (21) of each respective conductor (20), which has a second end portion (22) to be connected to a power inlet plug (8) of the shell (1); and
fixation means to be fitted into engagement receiving means provided in the female connector (10), in order to immobilize said parts against relative movements.

2. The connector according to claim 1, characterized in that the insulating body is in a single piece.

3. The connector according to claim 2, characterized in that the fixation means are defined by teeth (35) provided in the insulating body of the male connector (30) and which are resiliently deformed during the engagement of the male connector (30) to the female connector (10) and until each tooth (35) is engaged in a respective engagement receiving means provided in the female connector (10).

4. The connector according to claim 3, characterized in that the insulating body of the male connector (30) presents a prismatic form, with lateral walls (32) projecting from a rear wall (33), and with at least part of the confronting lateral walls thereof being provided with said teeth (35) and elastically deformable in the region where the respective teeth (35) are provided.

5. The connector according to claim 4, characterized in that the insulating body of the male connector (30) includes at least one internal wall (34) provided with a tooth (35).

6. The connector according to claim 5, characterized in that the insulating body of the male connector (30) includes a tooth (35) on each lateral wall (32) confronting with a respective internal wall (34).

7. The connector according to claim 1, characterized in that the engagement receiving means are windows produced in lateral walls of the body of the female connector (10).

8. The connector according to claim 1, characterized in that the insulating body of the male connector (30) includes retaining means that immobilize the first end portion of each conductor (20).

9. The connector according to claim 8, characterized in that the retaining means are defined by projections (36) provided from the rear wall (33) of the insulating body of the male connector (30), surrounding an adjacent portion of one of the lateral walls (32) of said insulating body.

10. A process for manufacturing an electric connector for the motor of a hermetic compressor, said motor carrying in the stator (6) thereof a female connector (10) for electric connection and being mounted inside a shell (1) to which is affixed a power inlet plug (8) for connection to an external current supply source, characterized in that it comprises the steps of:
a—providing an electric insulating body carrying a plurality of binding posts (31) connecting and affixing a first end portion of each respective conductor (20), which has a second end portion to be connected to the power inlet plug (8) of the shell (1);
b—mounting electric contact terminals of each conductor (20) to the binding posts (31) mounted to the electric insulating body of the male connector (30); and
c—over-injecting an insulating material to each first end portion (21) of each conductor (20) connected to the insulating body of the male connector (30), in order to immobilize said conductors.

11. Process, according to claim 10, characterized in that the step “b” is carried out in a mold that receives an injection of plastic.
